(19) United States
(12) Patent Application Publication
(10) Pub. No.: US 2013/0064567 A1
(43) Pub. Date: Mar. 14, 2013

(54) IMAGE FORMING APPARATUS INCLUDING VENTILATED IMAGING UNIT

(71) Applicants: Shiro AKAMA, Kanagawa (JP); Yuki SATO, Kanagawa (JP); Nobuhiro SHIMA, Kanagawa (JP)

(72) Inventors: Shiro AKAMA, Kanagawa (JP); Yuki SATO, Kanagawa (JP); Nobuhiro SHIMA, Kanagawa (JP)

(73) Assignee: RICOH COMPANY, LTD., Tokyo (JP)

(21) Appl. No.: 13/601,178

(22) Filed: Aug. 31, 2012

(30) Foreign Application Priority Data
Sep. 9, 2011 (JP) 2011-197669

(51) Int. Cl. G03G 15/00; G03G 21/20

(52) U.S. Cl. 399/90; 399/92; 399/93

(57) ABSTRACT

An image forming apparatus includes an imaging unit, a ventilator unit, and an electrical conductor. The imaging unit incorporates electrically powered equipment to which power is supplied from an external voltage source. The ventilator unit is connectable with the imaging unit to ventilate the imaging unit. The ventilator unit includes a fan and an air duct. The fan generates an airflow. The air duct extends from the fan to direct the airflow between the fan and the imaging unit. The electrical conductor is disposed within the air duct to electrically connect the imaging unit and the voltage source upon connection of the ventilator unit with the imaging unit.

### CROSS-REFERENCE TO RELATED APPLICATION

This patent application claims priority pursuant to 35 U.S.C. §119 to Japanese Patent Application No. 2011-197669, filed on Sep. 9, 2011, the entire disclosure of which is hereby incorporated by reference herein.

### BACKGROUND OF THE INVENTION

1. Technical Field

The present invention relates to an image forming apparatus, and more particularly, to an electrophotographic image forming apparatus, such as a photocopier, facsimile machine, printer, plotter, or multifunctional machine incorporating several of these features, which includes a ventilated imaging unit.

2. Background Art

In electrophotographic image forming apparatuses, such as photocopiers, facsimile machines, printers, plotters, or multifunctional machines incorporating several of those imaging functions, various pieces of imaging equipment are employed to perform a sequential electrophotographic process, including electrostatic charging of a photoconductive surface, exposure of the photoconductive surface to light creating an electrostatic latent image, and development of the latent image into a visible toner image, followed by transfer of the toner image from the photoconductive surface to a recording medium, such as a sheet of paper.

An image forming apparatus may incorporate one or more imaging units into which electrophotographic process modules, such as a photoconductor, a charging device, and a development device, are integrated into a single integrated unit for removable installation in the apparatus body. Such an imaging unit may be provided with a ventilator that ventilates and cools the imaging equipment, which tends to accumulate heat either generated internally (for example, by friction in rotary members), or radiated from an adjacent component such as the thermal fixing device. Accumulation of excessive heat, if not removed, would adversely affect imaging performance. In particular, overheat in the development device can cause formation of toner agglomerates in the developer, eventually leading to defects in resulting prints.

For example, there is known an image forming apparatus that includes a ventilation system connected to a plurality of imaging units incorporated therein. This ventilation system includes a plurality of pairs of supply units and exhaust units, the former having a combination of duct and fan for supplying air, and the latter having a combination of duct and fan for exhausting air, each pair dedicated to each of the plurality of imaging units for effectively cooling the respective imaging units.

In addition to ventilation, an imaging unit may also be provided with an electrical conductor which connects the imaging equipment with an external voltage source, such as power supply circuitry disposed within the apparatus body. Some components of the imaging equipment may require high-voltage power supply, for example, the charging device employing a charging roller or wire to which a high voltage is applied for inducing electrostatic discharge, and the development device employing a development roller to which a bias voltage is applied to generate an electrical bias between the photoconductor and the development roller.

Typically, power supply is conducted via electrical wiring and connectors disposed between the voltage source and the imaging unit. Implementing such electrical conduction can, however, compromise the compact size and easy assembly of the apparatus, where the use of bulky hardware connectors not only adds to the overall size of the imaging unit, but also makes it awkward to install the imaging unit due to the difficulty in handling the connectors within a limited space of the apparatus body.

Various techniques have been proposed to provide compact electrical connection for connecting an imaging unit with an external voltage source.

For example, an image forming apparatus has been proposed which can connect a removably installed, imaging unit with power supply circuitry without using bulky connectors. This method employs a moveable positioning membrane to which the imaging unit is mounted to be introduced into position within the apparatus body. The positioning membrane defines a groove along which a bare, unsheathed wire extends from the power supply circuitry as well as a guide slot for accommodating a power supply terminal of the imaging unit, such that the wiring contacts the power supply terminal where the imaging unit is set to a proper operational position.

Although effective for its intended purpose, the technique described above is not sufficient, where the electrical wiring is disposed along with a ventilator unit for cooling the imaging equipment. In the conventional configuration, connecting the ventilator and the high-voltage power conductor to the imaging unit may require a dedicated space and materials for insulation of power wiring from surrounding structure, resulting in a heavy bulky assembly with a large number of components, accompanied with a significant amount of costs and resources involved in the production process.

### SUMMARY OF THE INVENTION

Exemplary aspects of the present invention are put forward in view of the above-described circumstances, and provide a novel image forming apparatus.

In one exemplary embodiment, the image forming apparatus includes an imaging unit, a ventilator unit, and an electrical conductor. The imaging unit incorporates electrically powered equipment to which power is supplied from an external voltage source. The ventilator unit is connectable with the imaging unit to ventilate the imaging unit. The ventilator unit includes a fan and an air duct. The fan generates an airflow. The air duct extends from the fan to direct the airflow between the fan and the imaging unit. The electrical conductor is disposed within the air duct to electrically connect the imaging unit and the voltage source upon connection of the ventilator unit with the imaging unit.

### BRIEF DESCRIPTION OF THE SEVERAL VIEWS OF THE DRAWINGS

A more complete appreciation of the disclosure and many of the attendant advantages thereof will be more readily obtained as the same becomes better understood by reference to the following detailed description when considered in connection with the accompanying drawings, wherein:

FIG. 1 schematically illustrates an image forming apparatus according to one or more embodiments of this patent specification;

FIG. 2 is an end-on, axial view of an imaging unit included in the image forming apparatus of FIG. 1;

FIG. 3 is a perspective view of a plurality of imaging units assembled together with a ventilator unit included in the image forming apparatus of FIG. 1;

FIG. 4 is a cross-sectional view of the ventilator unit taken along lines 4-4 of FIG. 3;

FIG. 5 is a perspective view of the longitudinal end of the imaging unit of FIG. 3;

FIG. 6 is an enlarged perspective view of the portion enclosed by broken lines in FIG. 5;

FIG. 7 is a sectional perspective view of the ventilator unit taken along lines 7-7 of FIG. 3;

FIG. 8 is an enlarged, partial cross-sectional view of the ventilator unit according to another embodiment of this patent specification;

FIG. 9 is a sectional perspective view of the ventilator unit according to still another embodiment of this patent specification.

### DETAILED DESCRIPTION OF THE INVENTION

In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Referring now to the drawings, wherein like reference numerals designate identical or corresponding parts throughout the several views, exemplary embodiments of the present patent application are described.

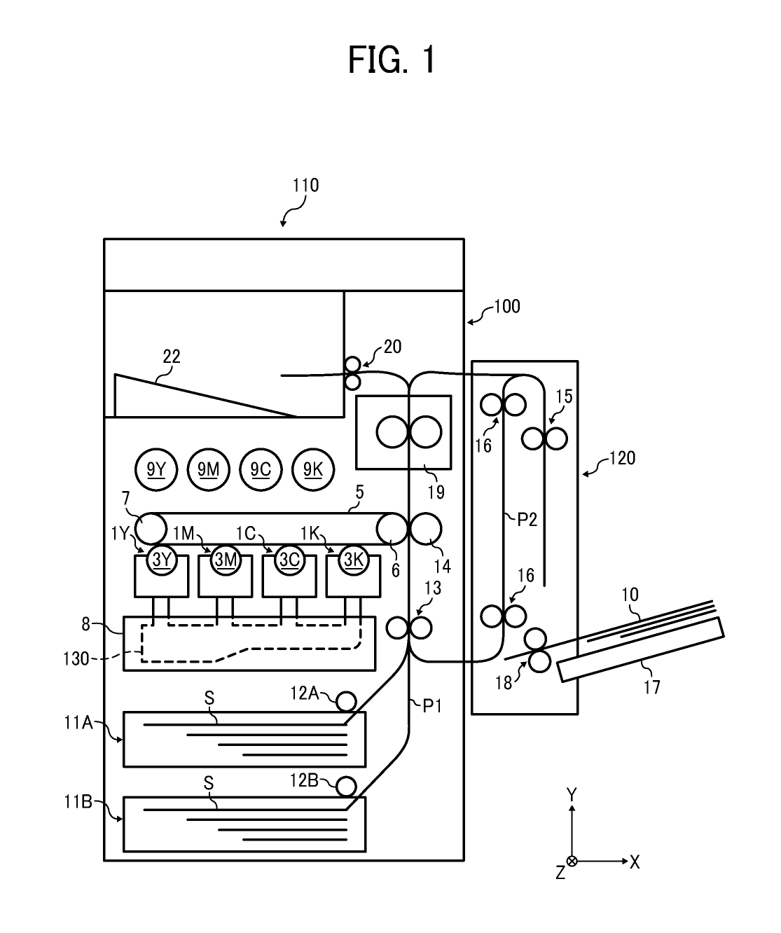

FIG. 1 schematically illustrates an image forming apparatus 100 according to one or more embodiments of this patent specification.

As shown in FIG. 1, the image forming apparatus 100 is a digital color imaging system including a main, printer body combined with an image scanning unit 110 and a duplex media reversal unit 120, which can print a color image on a recording medium such as a sheet of paper S according to image data.

Specifically, the image forming apparatus 100 comprises a tandem color printer, consisting of a plurality of electrophotographic imaging units 1Y, 1M, 1C, and 1K (collectively referred to as “imaging units 1”) arranged in series for forming primary images with toner particles of particular primary colors. The four imaging units 1Y, 1M, 1C, and 1K have a substantially identical configuration except for the color of toner used in image formation, as designated by the suffixes “Y” for yellow, “M” for magenta, “C” for cyan, and “K” for black. These suffix letters are used to distinguish corresponding components of the imaging units, and can be occasionally omitted where the description is applicable to all the imaging units or to those corresponding components.

As used herein, the term “horizontal direction” refers to a lateral direction in which the multiple imaging units are arranged sequentially, as represented by the axis “X” in the drawing. The term “longitudinal direction” refers to a direction perpendicular to the horizontal direction in which the multiple imaging units extend axially or longitudinally, as represented by the axis “Z” in the drawing. The term “vertical direction” refers to a direction perpendicular to both the horizontal and longitudinal directions, as represented by the axis “Y” in the drawing.

Each imaging unit 1 includes a drum-shaped photoconductor 3 rotatable clockwise in the drawing, having its outer, photoconductive surface surrounded by various pieces of imaging equipment, such as a charging device and a development device, not specifically shown in FIG. 1, which work in cooperation to form a primary toner image on the photoconductive surface. A primary transfer device incorporating an electrically biased, primary transfer roller is disposed facing the photoconductor 3 for transferring the toner image from the photoconductive surface.

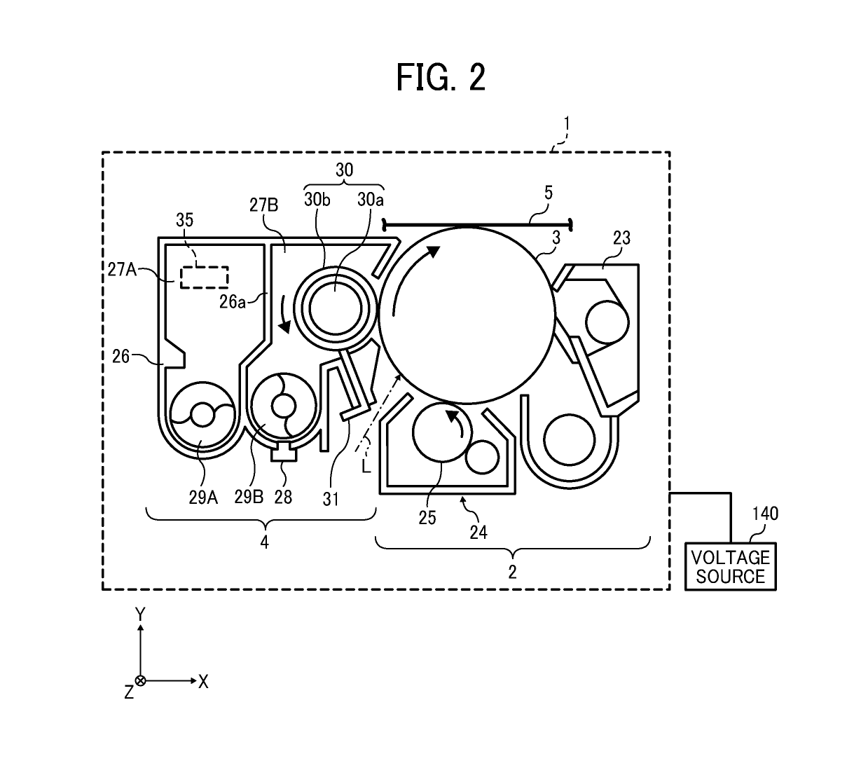

Disposed below the imaging units 1 are an exposure unit 8 and a ventilator unit 130. The exposure unit 8 includes an optical scanner to radiate a laser beam to the photoconductive surface. The ventilator unit 130 is connectable with the imaging units 1 to ventilate and cool the imaging units 1 each of which incorporates electrically powered equipment to which power is supplied from an external voltage source 140. Specific configurations of the imaging unit 1 and the ventilator unit 130 will be described later in more detail with reference to FIG. 2 and subsequent drawings.

Above the imaging units 1 extends an intermediate transfer belt 5 stretched for rotation around a driver roller 6 and a driven roller 7 to travel in the horizontal direction along the series of imaging units 1. A secondary transfer device incorporating an electrically biased, secondary transfer roller 14 is disposed facing the intermediate transfer belt 5 for transferring the toner image from the belt surface.

The intermediate transfer belt 5 is rotatable counterclockwise in the drawing, so as to sequentially pass through four primary transfer nips defined between the photoconductive drums 3 and the primary transfer rollers, at which the toner images are primarily transferred from the photoconductor 3 to the belt 5 to form a multicolor toner image, and then through a secondary transfer nip defined between the secondary transfer roller 14 and the backup, driver roller 6, at which the toner image is secondarily transferred from the belt 5 to a recording sheet S.

Replaceable toner bottles 9Y, 9M, 9C, and 9K are disposed above the intermediate transfer belt 5, each accommodating toner of a particular color for supply to the development device of an associated imaging unit 1.

At a lower portion of the apparatus body is a pair of sheet trays 11A and 11B disposed in tiers, each accommodating a stack of recording sheets S of a particular size. The recording medium used in electrophotographic image formation may be any material onto which a toner image is transferred and fixed in place, including paper and various types of materials which are designated as transfer paper, copy paper, print sheets, or recording sheets.

A pickup roller 12 is disposed at an outlet of each sheet tray 11 to feed the sheets S one by one from the sheet stack. Multiple conveyance rollers are disposed to define a main sheet conveyance path P1, along which the recording sheet S is introduced by a pair of registration rollers 13 into the secondary transfer nip, and then enters a fixing device 19 that fixes the toner image in place on the recording sheet S. A pair of output rollers 20 is disposed at the end of the sheet conveyance path P1 for outputting the recording sheet S to an output sheet tray 22.

The image scanning unit 110 is disposed atop the apparatus body which allows capturing image data from original documents supplied by a user. The scanning unit 110 includes a contact glass and a foldable platen cover or automatic document feeder (ADF) for positioning an original document on the contact glass, as well as an image scanner incorporating an image sensor, such as a charge-coupled device (CCD) image sensor, with a light source and optical assembly disposed below the contact glass for optically scanning the original document.

The duplex media reversal unit 120 is disposed at one lateral side of the apparatus body to convey a recording sheet S from the fixing device 19 to the registration roller pair 13 while turning it upside down, which allows for printing on both sides of the recording sheet S. The duplex unit 120 includes a pair of reversal rollers 15 and other conveyance roller pairs 16 to define a subsidiary sheet conveyance path P2, along which the recording sheet S after processing through the fixing unit 19 is reversed for subsequent re-entry into the main sheet conveyance path P1. Additionally, the duplex unit 120 may have a manual input tray 17 into which a user may manually input a recording sheet S, which is subsequently introduced into the main sheet conveyance path P1 by a pair of conveyance rollers 18.

During operation, the image forming apparatus 100 may perform color image reproduction either as a photocopier or as a printer depending on the way its controller or central processing unit (CPU) acquires original image data. As a photocopier, the image forming apparatus 100 generates color image data based on information captured by the image scanning unit 110 activated where a user inputs an original document to be reproduced and presses a start button on a control panel. As a printer, the image forming apparatus 100 generates color image data based on a print request and a print job transmitted from a host device, such as a personal computer, connected to the apparatus via a suitable network.

Upon acquisition of color image data, the controller directs all the four imaging units 1 and the exposure unit 8 to initiate a sequential electrophotographic process, including charging, exposure, development, and transfer, in one rotation of the photoconductor drum 3.

First, the photoconductive surface is uniformly charged to a specific polarity by the charging device and subsequently exposed to a modulated laser beam emitted from the exposure unit 8. The laser exposure selectively dissipates the charge on the photoconductive surface to form an electrostatic latent image thereon according to image data representing a particular primary color. Then, the latent image enters the development device which renders the incoming image visible using toner. The toner image thus obtained is forwarded to the primary transfer device which electrostatically transfers the primary toner image to the intermediate transfer belt 5 through the primary transfer nip.

As the multiple imaging units 1 sequentially produce toner images of different colors at the four transfer nips along the belt travel path, the primary toner images are superimposed one atop another to form a single multicolor image on the moving surface of the intermediate transfer belt 5 for subsequent entry to the secondary transfer nip between the secondary transfer roller 14 and the backup roller 6.

Meanwhile, the pickup roller 12 picks up a recording sheet S from atop the sheet stack in a selected one of the sheet trays 11 that accommodates recording sheets of a size proportional to the image data, and introduces it between the pair of registration rollers 13 being rotated. Upon receiving the incoming sheet S, the registration rollers 13 stop rotation to hold the sheet S therebetween, and then advance it in sync with the movement of the intermediate transfer belt 5 to the secondary transfer nip.

At the secondary transfer nip, the multicolor tone image is transferred from the belt 5 to the recording sheet S, which is then introduced into the fixing device 19 to fix the toner image in place with heat and pressure. After fixing, the recording sheet S is output to the output tray 22 by the output roller pair 20, which completes one operational cycle of the image forming apparatus 100.

Where desired, the image forming apparatus 100 may be used to reproduce a monochrome, black-and-white image instead of a multicolor image. In such cases, the image forming apparatus 100 generates monochrome image data based on information captured by the image scanning unit 110 or print information transmitted from a host device, upon which the controller directs the black imaging unit 1K and the exposure unit 8 to form a black toner image on the photoconductor 3, followed by primary transfer from the photoconductive surface to the intermediate transfer belt 5, and then by secondary transfer from the belt 5 to the recording sheet S.

FIG. 2 is an end-on, axial view of the imaging unit 1 included in the image forming apparatus 100.

As shown in FIG. 2, the imaging unit 1 consists of one or more functional modules or subunits, including the photoconductor unit 2 and the development unit 4, which are removably installed in the image forming apparatus 100 either as a single integrated unit or as several separate components. An external voltage source 140, such as high-voltage power supply circuitry provided in the image forming apparatus 100, is connected to the imaging unit 1 upon installation of the imaging unit 1 in the image forming apparatus 100.

The photoconductor unit 2 includes, in addition to the drum-shaped photoconductor 3, a cleaning device 23 for cleaning the photoconductive surface, a charging device 24 for electrostatically charging the photoconductive surface, and a discharging device for removing electrostatic charge from the photoconductive surface, which are disposed in series around the photoconductor drum 3. A rotary drive motor may be provided in the photoconductor unit 2, which imparts torque to rotate the photoconductor drum 3.

In the photoconductor unit 2, the charging device 24 includes an electrically biased member 25 to which a high-potential bias voltage is applied from the voltage source 140 to impart electrostatic charge to the photoconductor drum 3. Such a charging member 25 may be a roller or brush charger disposed adjacent to or in contact with the photoconductive surface. Alternatively, instead, the charging member 25 may be a corona charger, such as a scorotron assembly, including a wire electrode disposed adjacent to the photoconductive surface. In the present embodiment, the charging member 25 comprises an electrically biased, rotatably driven roller disposed adjacent to the photoconductive surface.

The development unit 4 includes an enclosure housing 26 defining a developer container within which developer formed of a mixture of magnetic carrier and negatively chargeable toner particles is accommodated. The enclosure housing 26 is divided by a partition 26a into a pair of first and second compartments 27A and 27B, with one or more openings defined in the partition 26a through which the first and second compartments 27A and 27B communicate with each other.

In the enclosure housing 26 is a pair of rotatably driven, first and second screw conveyors 29A and 29B, the former disposed in the first compartment 27A and the latter disposed in the second compartment 27B, to circulate the developer from one compartment to the other. A toner concentration sensor 28, including a permeameter and its associated circuitry, is disposed at a bottom side of the second compartment 27B for measuring a concentration of toner in the developer being contained.

Disposed above and parallel to the second screw conveyor 29B is a developer applicator 30 to which a high-potential bias voltage is applied from the voltage source 140 for drawing the developer from the container for subsequent application to the photoconductive surface. The developer applicator 30 is formed of a combination of a magnet roller 30a covered with a rotatable, nonmagnetic pipe or sleeve 30b. The developer applicator 30 is equipped with a doctor blade 31 having its blade edge closely spaced apart from the rotatable sleeve 30b to regulate a thickness of developer carried on the applicator surface.

During operation, the photoconductive drum 3 rotates clockwise in the drawing, so as to advance its photoconductive surface sequentially through the charging device 24, the development device 4, the primary transfer nip, and then the drum cleaner 23.

In the charging device 24, the charging roller 25 is electrified with the bias voltage while rotating in a rotational direction opposite that of the photoconductor 3, so as to uniformly distribute electrostatic charge over the surface of the photoconductive drum 3. The photoconductive surface thus uniformly charged is subsequently exposed to a laser beam L, which selectively removes charge from the photoconductive surface to create an electrostatic latent image thereon.

In the development device 4, the screw conveyors 29A and 29B rotate in their predetermined rotational directions, so that the developer flows from one end to another of the first compartment 27A in one axial direction Z+ (away from the viewer in FIG. 2), exiting the first compartment 27A to enter the second compartment 27B through the opening in the partition 26a, and then flows from one end to another of the second compartment 27B in another, opposite axial direction Z− (toward the viewer in FIG. 2).

As the developer travels in the second compartment 27B, the magnet roller 30a magnetically attracts part of the developer onto the surface of the nonmagnetic sleeve 30b to create a layer of developer thereon, the thickness of which is regulated by the doctor blade 31 as the sleeve 30b rotates in a rotational direction opposite that of the photoconductor drum 3. Upon entering a gap defined between the photoconductor 3 and the developer applicator 30, toner carried on the sleeve 30b is attracted by the electrostatic latent image on the photoconductive surface to render it into a visible, toner image.

After exiting the development device 4, the photoconductive surface enters the primary transfer nip defined between the photoconductor 3 and the intermediate transfer belt 5 at which the toner image is transferred from the photoconductive surface to the belt surface. Thereafter, the photoconductive surface reaches the drum cleaner 23 which removes residual toner particles from the photoconductive surface, followed by the discharging device removing residual charge from the photoconductive surface, upon which the photoconductor drum 3 is prepared for a subsequent imaging cycle.

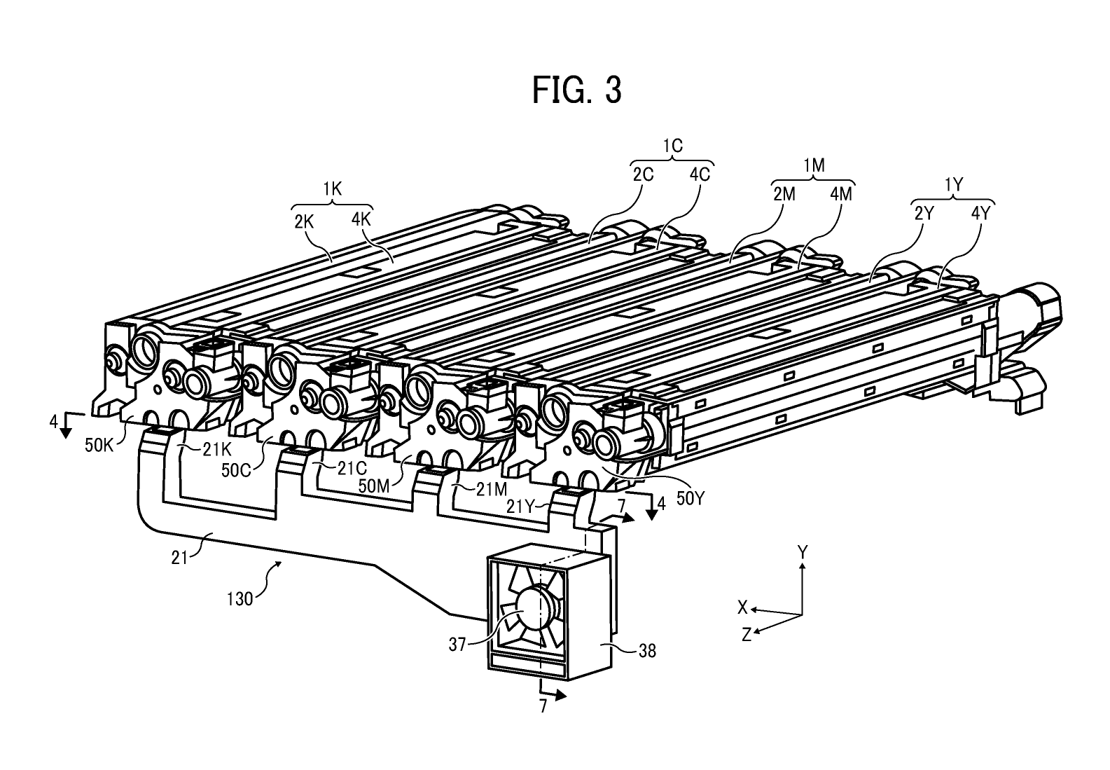

FIG. 3 is a perspective view of the plurality of imaging units 1Y, 1M, 1C, and 1K assembled together with the ventilator unit 130.

As shown in FIG. 3, and as mentioned earlier, the image forming apparatus 100 includes the imaging units 1Y, 1M, 1C, and 1K each incorporating electrically powered equipment, such as the photoconductor unit 2 and the development unit 4, to which power is supplied from the external voltage source 140, and the ventilator unit 130 connectable with the imaging units 1 to ventilate the imaging units 1. The ventilator unit 130 includes a fan 37 to generate an airflow, and an air duct 21 extending from the fan 37 to direct the airflow between the fan 37 and each imaging unit 1.

Specifically, in the present embodiment, the plurality of imaging units 1Y, 1M, 1C, and 1K are arranged in series in the horizontal direction X in which the intermediate transfer belt 5 travels, with their respective longitudinal axes directed in the axial, longitudinal direction Z perpendicular to the horizontal direction X upon installation in the image forming apparatus 100.

At one longitudinal end of each imaging unit 1 is an end cover 50 which, together with an exterior wall of the imaging unit 1, defines an air chamber that leads to a space inside or outside the enclosure of the imaging unit 1. For example, in the present embodiment, the air chamber may be connected to the inside of the development unit 4 through a vent hole 35 defined in the wall of the enclosure housing 26 at one longitudinal end of the first compartment 27A, as shown in FIG. 2. A similar vent hole may be provided to the charging device 24 where cooling of the charging device 24 is required.

The air duct 21 generally extends in the vertical direction Y perpendicular to the horizontal and longitudinal directions X, with its distal ends connected to the air chambers of the imaging units 1, and its proximal end connected to a housing 38 which defines a space in which the fan 37 is accommodated in fluid communication with the air duct 21.

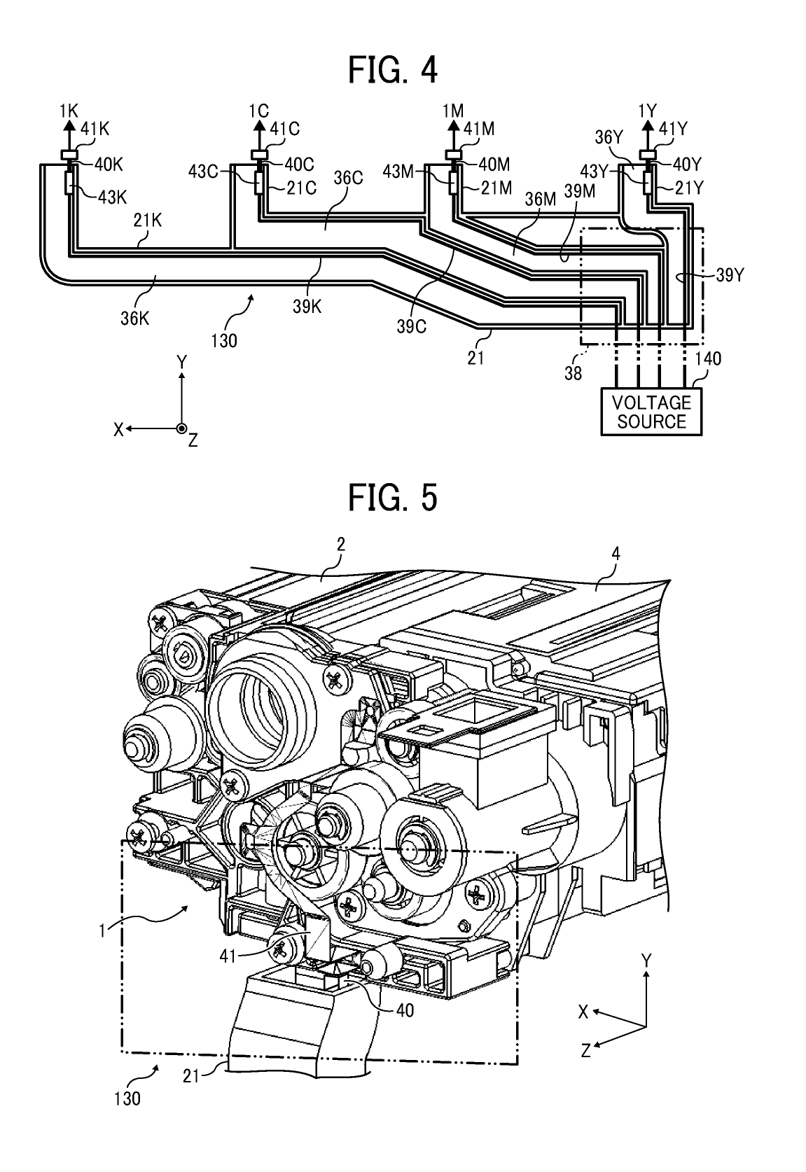

With additional reference to FIG. 4, which is a cross-sectional view of the ventilator unit 130 taken along lines 4-4 of FIG. 3, the air duct 21 is shown comprising a manifold that has a plurality of branching ducts 21Y, 21M, 21C, and 21K, each extending from the fan 37 to direct the airflow between the fan and an associated one of the plurality of imaging units 1. The manifold duct 21 defines a plurality of airflow channels 36Y, 36M, 36C, and 36K therewithin, each having one end connected to the fan housing 38 and another end connected to the air chamber of an associated imaging unit 1.

The air duct 21 may be a tube of non-metallic, electrically insulating material, such as a molded piece of synthetic resin, or alternatively, a tube of electrically conductive material, such as a formed metal plate. The air duct 21 and the fan housing 28 may be formed of a single, integral piece of material.

The ventilator unit 130 is configured as an exhaust ventilator that exhausts air from the imaging unit 1 to outside, with the air duct 21 being an exhaust duct directing air from the imaging unit 21 to the fan 37, and the fan 37 being an exhaust fan that generates an airflow away from the air duct 21.

During operation, activation of the exhaust fan 37 creates an airflow from the imaging units 1 toward the fan 37 through the airflow channels 36 to draw air from the air chamber at the end of each imaging units 1, which in turn draws heated air through the air vent 35 from inside the enclosure housing 26 of the development unit 4. Ventilation through the air vent 35 removes heat not only from the first compartment 27A but also from the second compartment 27B communicating therewith, so as to prevent accumulation of heat generated by friction in the rotating screws 29A and 29B, or that radiated from an adjacent component such as the thermal fixing device, which would otherwise cause formation of toner agglomerates in the developer, eventually leading to defects in resulting prints.

Although a specific configuration is described in the embodiment above, the configuration of the imaging units 1 and the ventilator unit 130 may be other than that specifically depicted herein.

For example, instead of an exhaust ventilator, the ventilator unit 130 may be configured as a supply ventilator that supplies air to the imaging unit from outside, with the air duct 21 being a supply duct directing air to the imaging unit 21 from the fan 37, and the fan 37 being a supply fan that generates an airflow into the air duct 21.

Also, instead of supplying the airflow inside the imaging unit 1, the ventilator unit 130 may be configured to supply the airflow around the imaging unit 1. In such cases, the air duct 21 is connected to suitable spacing between adjoining imaging units 1, such that the airflow flows along the exterior walls of the imaging units 1 or the subunits thereof, thereby allowing the imaging equipment to be cooled from outside the enclosure housing.

With specific reference to FIG. 4, an elongated, electrical conductor 39 is shown disposed within each of the plurality of branching ducts 21 to electrically connect the imaging units 1 and the voltage source 140 upon connection of the ventilator unit 130 with the imaging units 1.

Specifically, the electrical conductor 39 extends along the airflow channel 36, having an output terminal 40 thereof projecting beyond an open end of the air duct 21 for connecting to a power supply terminal 41 of the associated imaging unit 1, and an input terminal thereof extending from another open end of the air duct 21 for connecting to an electrical terminal of the voltage source 140. A suitable fastener 43 may be provided to secure the conductor 39 in place by affixing the output terminal 40 to an inner wall of the air duct 21.

The electrical conductor 39 comprises a wire or strip of electrically conductive material, such as copper, aluminum, or the like, either sheathed or unsheathed with electrically isolating material. Where the power supplied to the imaging unit 1 is relatively high, the conductor 39 may be configured as a bare, uninsulated wire, with the air duct 21 being a tube of electrically insulating material. A non-metallic, insulative material is ready to mold into a tubular configuration of the duct 21, while providing sufficient insulation for the conductor 39 even where the conductor 39 itself is not covered with insulating material, leading to a simple, inexpensive design of the duct assembly. Alternatively, instead, where the power supplied to the imaging unit 1 is relatively low, the conductor 39 may be configured as an electrically insulated wire, with the air duct 21 being a tube of electrically conductive material.

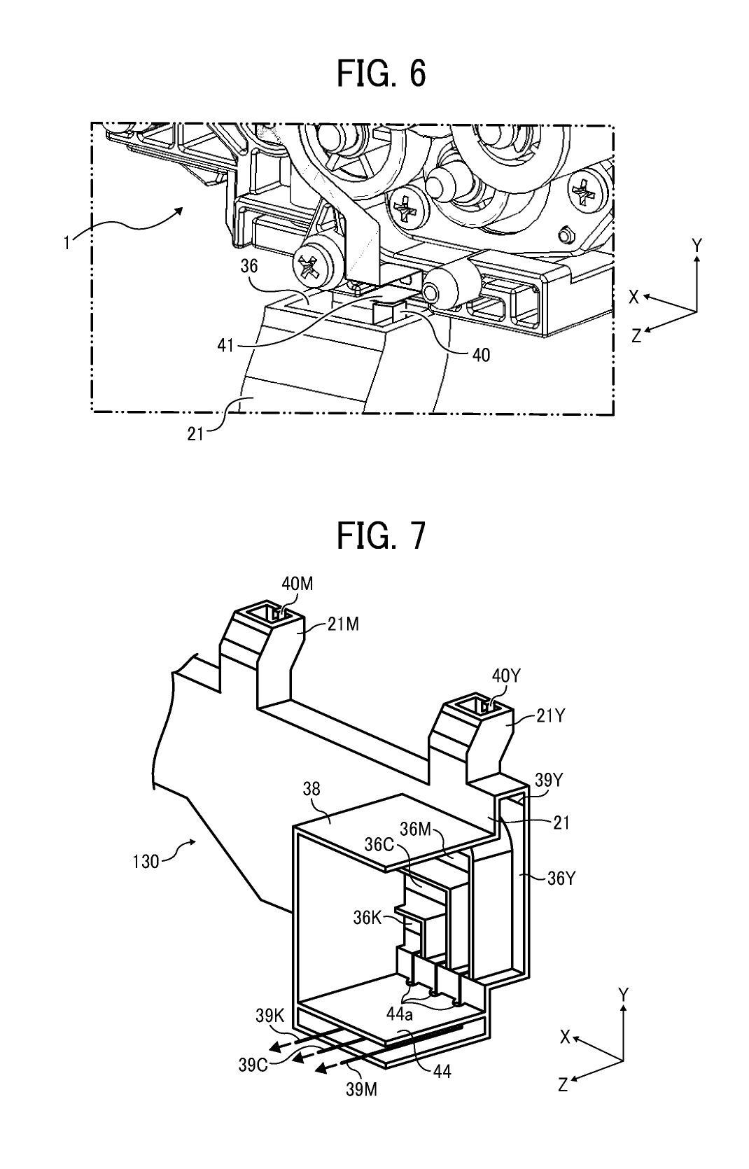

FIG. 5 is a perspective view of the longitudinal end of the imaging unit 1, shown with the end cover 50 removed, and FIG. 6 is an enlarged perspective view of the portion enclosed by broken lines in FIG. 5.

As shown in FIGS. 5 and 6, upon installation of the imaging unit 1 and the ventilator unit 130 in their respective operational positions, the power supply terminal 41 at the longitudinal end of the imaging unit 1 is aligned with the output terminal 40 of the conductor 39, such that the terminals 40 and 41 press against each other to establish an electrical contact therebetween, through which high-voltage power may be supplied from the voltage source 140 to the imaging equipment, including either or both of the developer applicator 30 of the development unit 4 and the charging roller 25 of the charging device 24.

The electrical connection formed by contacting the terminals 40 and 41 between the conductor 39 and the imaging unit 1 allows for a simple, compact configuration of the imaging unit, since it does not require a large space or bulky hardware connectors, which would add to the overall size of the imaging unit while making it awkward to install the imaging unit due to the difficulty in handling the connectors within a limited space of the apparatus body.

Although in the embodiment described above, each branching duct of the manifold 21 is depicted as accommodating a single conductor, the number of conductors disposed within the air duct may be other than that depicted in FIG. 4. That is, where different components of the imaging unit 1 require power supplies of different voltages or other electrical characteristics, multiple independent conductors may deployed within each branching air duct. In such cases, a suitable insulation may be disposed between those adjoining conductors, for example, by creating raised surfaces or grooves on the inner wall of the duct 21 to separate the conductors apart from each other (in which case the duct 21 is formed of conductive material), by covering the conductors with insulating material (in which case the duct 21 is formed of either conductive or non-conductive material), or by dividing each duct branch into narrower separate airflow channels each of which is dedicated to a particular one of the multiple conductors.

FIG. 7 is a sectional perspective view of the ventilator unit 130 taken along lines 7-7 of FIG. 3, shown with the fan 37 removed from the housing 38.

As shown in FIG. 7, the fan housing 38, which is integrally formed with the air duct 21 in the present embodiment, comprises a rectangular enclosure provided on the proximal end of the air duct 21, with all the branching ducts 21 being open to the inside of the housing 38. The housing 38 is provided with a partition 44 that divides the housing 38 into upper and lower compartments, the former for accommodating the fan 37 therewithin and the latter for passing the conductors 39 therethrough. Four notches 44a are defined in the partition 44, of which only three is visible in FIG. 7, such that the conductors 39 entering the upper compartment extend via the notches 44a to the lower compartment for subsequent connection to the external voltage source 140.

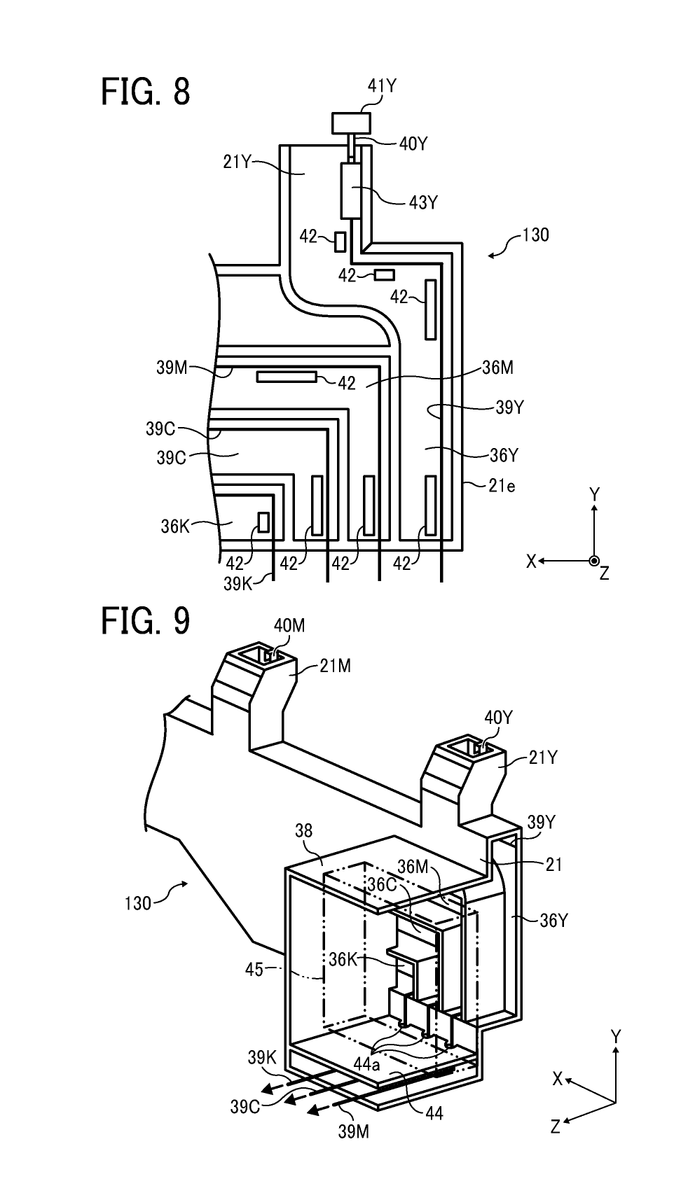

FIG. 8 is an enlarged, partial view of the ventilator unit 130 according to another embodiment of this patent specification.

As shown in FIG. 8, the overall configuration of the present embodiment is similar to that depicted in FIG. 4, except that the ventilator unit 130 further includes a retainer 42 for retaining the conductor 39 in position along the air duct 21.

Specifically, the retainer 42 may be configured as multiple elongated protrusions disposed on the inner wall of the air duct 21, several of which are visible in FIG. 8, such that the protrusions and the duct inner wall together define a path along which the conductor 39 is properly routed between the opposite ends of the airflow channel 36. In particular, the protrusions 42 are deployed at those portions where the airflow channel 36 bends or curves. The protrusions 42 may be formed of suitable material such as synthetic resin, either integrally with or separate from the inner wall of the air duct 21.

FIG. 9 is a sectional perspective view of the air duct 21 included in the ventilator unit 130 according to still another embodiment of this patent specification.

As shown in FIG. 9, the overall configuration of the present embodiment is similar to that depicted in FIG. 7, except that the ventilator unit 130 further includes a filter 45 interposed between the fan 37 and the air duct 21 for removing particulate matter or other contaminants from the airflow passing therethrough. A suitable type of filter is selected depending on specific configuration of the ventilator unit 130.

For example, where the air duct 21 terminates in or adjacent to the development unit 4 to communicate the airflow with the development device, the filter 45 is configured as a toner filter interposed between the fan 37 and the air duct 21 to remove toner particles escaping from the development unit 4 into the fan housing 38. Such arrangement allows the ventilator unit 130 to filter out airborne toner particles present in air exhausted from the development device, which, if emitted together with the airflow, would contaminate the inside or outside of the image forming apparatus.

Alternatively, where the air duct 21 terminates in or adjacent to the charging device 24 to communicate the airflow with the charging device 24, the filter 45 is configured as an ozone filter interposed between the fan 37 and the air duct 21 to remove ozone escaping from the charging device 24 into the fan housing 38. Such arrangement allows the ventilator unit 130 to filter out ozone generated by electrostatic discharge and present in air exhausted from the charging device, which, if emitted together with the airflow, would spread outside to breathed in through air.

Further, where the air duct 21 is directed to ventilate both of the development unit 4 and the charging unit 24, the filter 45 is configured as a combination of a toner filter and an ozone filter interposed between the fan 37 and the air duct 21.

Hence, the image forming apparatus 100 according to this patent specification includes an imaging unit 1 incorporating electrically powered equipment to which power is supplied from an external voltage source 140; a ventilator unit 130 consisting of a fan 37 and an air duct 21 connectable with the imaging unit 1; and an electrical conductor 39 disposed within the air duct 21 to electrically connect the imaging unit 1 and the voltage source 140 upon connection of the ventilator unit 130 with the imaging unit 1.

Compared to a conventional configuration in which a ventilator and a high-voltage power conductor are separately connected to an imaging unit, provision of the conductor within the air duct eliminates the need for a dedicated space and materials for insulation of power wiring from surrounding structure, thereby allowing for a compact, lightweight, inexpensive, and resource-saving imaging system. In particular, the air duct configured as a tube of electrically insulating material provides sufficient insulation for a bare, uninsulated wire, through which a high-voltage power supply may be conducted to the imaging equipment from the external voltage source.

The electrical conductor disposed within the ventilating air duct according to this patent specification is applicable to any type of ventilated imaging unit that incorporates electrically powered equipment to which power is supplied from an external power source. Also, the image forming apparatus is not limited to a tandem color printer with an intermediate transfer capability, but includes any type of image forming apparatus, such as a photocopier, facsimile machine, printer, plotter, or multifunctional machine incorporating several of those imaging functions, which may be designed with either a direct transfer unit or an intermediate transfer unit, and which may be configured to perform either monochrome printing or multicolor printing.

Numerous additional modifications and variations are possible in light of the above teachings. It is therefore to be understood that, within the scope of the appended claims, the disclosure of this patent specification may be practiced otherwise than as specifically described herein.

What is claimed is:

1. An image forming apparatus, comprising:
an imaging unit incorporating electrically powered equipment to which power is supplied from an external voltage source;
a ventilator unit connectable with the imaging unit to ventilate the imaging unit, the ventilator unit comprising:
a fan to generate an airflow; and
an air duct extending from the fan to direct the airflow between the fan and the imaging unit; and
an electrical conductor disposed within the air duct to electrically connect the imaging unit and the voltage source upon connection of the ventilator unit with the imaging unit.

2. The image forming apparatus according to claim 1, wherein the conductor comprises a bare, uninsulated wire, with the air duct being a tube of electrically insulating material.

3. The image forming apparatus according to claim 1, wherein the conductor comprises an electrically insulated wire, with the air duct being a tube of electrically conductive material.

4. The image forming apparatus according to claim 1, wherein the ventilator unit further comprises a retainer for retaining the conductor in position along the air duct.

5. The image forming apparatus according to claim 4, wherein the retainer comprises multiple elongated protrusions disposed on an inner wall of the air duct, such that the protrusions and the duct inner wall together define a path along which the conductor is routed.

6. The image forming apparatus according to claim 1, wherein the ventilator unit is a supply ventilator that supplies air to the imaging unit from outside.

7. The image forming apparatus according to claim 1, wherein the ventilator unit is an exhaust ventilator that exhausts air from the imaging unit to outside.

8. The image forming apparatus according to claim 1, wherein the electrically powered equipment includes a development device that develops a latent image using toner,
the air duct terminating in or adjacent to the development device to communicate the airflow with the development device,
the ventilator unit further comprises a toner filter interposed between the fan and the air duct to remove toner particles escaping from the development device.

9. The image forming apparatus according to claim 1, wherein the electrically powered equipment includes a charging device that electrostatically charges a photoconductive surface,
the air duct terminating in or adjacent to the charging device to communicate the airflow with the charging device,
the ventilator unit further comprises an ozone filter interposed between the fan and the air duct to remove ozone escaping from the charging device.

10. The image forming apparatus according to claim 1, wherein the electrically powered equipment includes:
a development device that develops a latent image using toner; and
a charging device that electrostatically charges a photoconductive surface,
the air duct terminating in or adjacent to the development device and the charging device to communicate the airflow with the development device and the charging device,
the ventilator unit further comprises:
a toner filter interposed between the fan and the air duct to remove toner particles escaping from the development device; and
an ozone filter interposed, in combination with the toner filter, between the fan and the air duct, to remove ozone escaping from the charging device.

11. An image forming apparatus, comprising:
a plurality of imaging units each incorporating electrically powered equipment to which power is supplied from an external voltage source;
a ventilator unit connectable with each of the plurality of imaging units to ventilate the plurality of imaging units, the ventilator unit comprising:
a fan to generate an airflow; and
a plurality of air ducts each extending from the fan to direct the airflow between the fan and an associated one of the plurality of imaging units; and
an electrical conductor disposed within each of the plurality of branching air ducts to electrically connect the imaging unit and the voltage source upon connection of the ventilator unit with the imaging unit.
